(19) United States
(12) Patent Application Publication
(10) Pub. No.: US 2006/0218861 A1
(43) Pub. Date: Oct. 5, 2006

(54) Cachepot and the like made of fabric preferably without lateral seams

(76) Inventor: Antonio Sgaravatti, Padova (IT)

Correspondence Address: Modiano & Associati, Via Meravigli 16, Milano, 20123, IT

(21) Appl. No.: 10/557,808

(22) PCT Filed: May 24, 2004
(86) PCT No.: PCT/EP04/05565

§ 371 Date: Nov. 23, 2005

(30) Foreign Application Priority Data
Jun. 3, 2003 (IT) PD2003U000044

(51) Int. Cl. A01G 9/02

(52) U.S. Cl. 47/65.7

(57) ABSTRACT

A cachepot made of fabric that can be applied also to pots with associated pot saucers, comprising a tubular element made of elastic fabric in order to adapt to a shape of a pot or of a pot with pot saucer to which it can be applied, the tubular element having two end borders that are also elastic.

### TECHNICAL FIELD

The present invention relates to a cachepot made of fabric, particularly for pots of flowers, plants and the like.

Such cachepot can be applied conveniently also to sets of pots and associated pot saucers.

### BACKGROUND ART

It is known that pots for flowers, plants and the like, generally made of plastics or terracotta, do not have a pleasant aesthetic appearance.

Often, when these pots are kept inside homes or outside in highly visible positions (such as for example on balconies or close to entrances), they are covered at least partially by cachepot elements in order to make them more pleasant to see.

A first type of cachepot element that is currently known is constituted substantially by a tubular band of paper-like material that covers laterally the pot to which it is applied.

The tubular band of material is pleated in concertina fashion longitudinally in order to allow it to widen and therefore adapt elastically to pots of different diameters.

Leaving aside the aesthetic improvement that these paper cachepots supposedly provide (which is entirely unproven), it is evident that these products are indeed adaptable to pots having different diameters but cannot be adapted to pots that have significantly different heights.

Further, the cachepots, being made of paper-like material, are not very strong and can deteriorate over time.

Moreover, since the cachepots are made of paper-like material, they cannot be washed and therefore in case of dirt (such as for example the typical case of water mixed with earth that spills from the pot) they have to be replaced.

Another problem, linked to the aesthetic appearance of the pot, derives from the fact that the cachepots made of paper-like material do not cover the water collection saucer, which is almost always present and is another unsightly factor.

A second type of cachepot element that is currently known is substantially constituted by aesthetic finishing pots, which contain the pots that contain the flowers and optionally the saucer as well.

It is evident that this type of cachepot also has problems similar to those of the previously described cachepots.

These cachepots are in fact “rigid” and cannot be adapted to the dimensions of the various pots, since they are able to accommodate small pots but not pots that are larger than their structure.

Moreover, the cost of these “rigid” cachepots can be substantial, depending on their dimensions, materials and finish.

### DISCLOSURE OF THE INVENTION

The aim of the present invention is to provide a cachepot, particularly but not exclusively applicable to pots, with or without pot saucers, for flowers, plants and the like, that allows to solve the problems linked to known types of cachepot.

Within this aim, an object of the present invention is to provide a cachepot, particularly but not exclusively applicable to pots, with or without pot saucers, for flowers, plants and the like, that can be adapted to a wide variety of pots and pot saucers.

Another object of the present invention is to provide a cachepot, particularly but not exclusively applicable to pots, with or without pot saucers, for flowers, plants and the like, that is cheap, tough and cleanable.

Another object of the present invention is to provide a cachepot, particularly but not exclusively applicable to pots, with or without pot saucers, for flowers, plants and the like, that is aesthetically pleasant.

Another object of the present invention is to provide a cachepot, particularly but not exclusively applicable to pots, with or without pot saucers, for flowers, plants and the like, that can be manufactured with conventional systems and technologies.

This aim and these and other objects that will become better apparent hereinafter are achieved by a cachepot made of fabric, characterized in that it comprises a tubular element made of elastic fabric in order to adapt to the shape of the pot or of the pot with pot saucer to which it can be applied, said tubular element having two end borders that are also elastic.

### BRIEF DESCRIPTION OF THE DRAWINGS

Further characteristics and advantages of the present invention will become better apparent from the following detailed description of a preferred but not exclusive embodiment thereof, illustrated by way of non-limiting example in the accompanying drawings, wherein:

FIG. 1 is a view of a cachepot according to the invention to be applied to a pot;

FIG. 2 is a perspective view of a cachepot according to the invention, applied to a pot;

FIG. 3 is a perspective view of the cachepot according to the invention, applied to a pot with pot saucer.

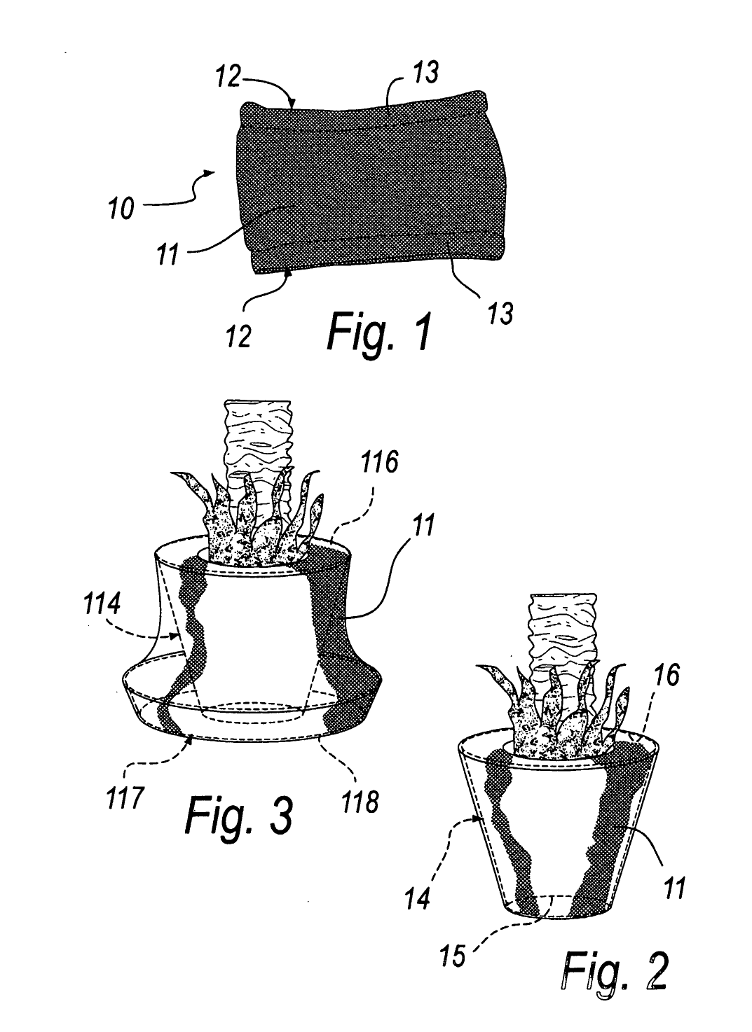

### WAYS OF CARRYING OUT THE INVENTION

With reference to the figures, a cachepot according to the invention is generally designated by the reference numeral 10.

The cachepot 10 comprises a tubular element 11 made of elastic fabric.

Preferably, the fabric is made of elasticized knitted material, such as for example stretch fabrics.

The tubular element 11 has two end borders 12, which are also elastic.

Each one of the end borders 12 forms an elastic edge 13, which can have different heights.

The tubular element 11 has regions with differentiated elasticity. In this case, these regions are the elastic edges 13.

Indicative measurements, given merely by way of example, are as follows:
diameter of the tubular element 11: 5 to 50 cm;
height of the tubular element 11: 5 to 50 cm;
height of the elastic edge 13: 1 to 10 cm.

The tubular element 11 is fitted over the pot, here designated by the reference numeral 14; the end borders 12 grip the pot 14, extending onto its underside 15 and onto its top rim 16. In this manner, its lateral surface is covered completely.

The elastic fabric allows complete adaptation of the cachepot 10 to the shape of the pot 14 and also allows to use it even with pots that are larger both in diameter and in height.

Advantageously, as shown in FIG. 3, the cachepot, by way of its elasticity, can also be applied to a pot 114 with a pot saucer 117.

In this case, the tubular element 11 is fitted over the pot saucer 117 as well as over the pot 114; the end borders 12 grip the saucer 117, extending onto its resting base 118, and grip the pot 114 on its upper rim 116. In this manner, the lateral surface of the pot and of the pot saucer is covered completely.

It should also be noted that the tubular element 11 prevents, if its “porosity” (or mesh width) is sufficiently tight, the access of mosquitoes to the reserve of stagnant water that inevitably forms in the saucer.

Advantageously, in order to protect the pot and therefore the roots of plant contained therein from temperature variations, the tubular element 11 can be made of a fabric that has thermal insulation properties.

The tubular element 11 is preferably made of washable fabric that also has anti-mold properties.

For safety reasons, the tubular element 11 can be made of a fabric that has fire-resistant and/or self-extinguishing properties.

In practice it has been found that the invention thus described solves the problems noted in known types of cachepot; in particular, the present invention provides a cachepot, applicable particularly but not exclusively to pots, with or without pot saucers, for flowers, plants and the like, that can be adapted to a wide variety of pots and pot saucers.

Moreover, the present invention provides a cachepot, particularly but not exclusively applicable to pots, with or without pot saucers, for flowers, plants and the like, that is particularly cheap, tough and easy to clean.

Further, the present invention provides a cachepot, particularly but not exclusively applicable to pots, with or without pot saucers, for flowers, plants and the like, that is aesthetically pleasant and can also count on a wide variety of decoration colors associable with the type of fabric used.

Moreover, the present invention provides a cachepot, particularly but not exclusively applicable to pots, with or without pot saucers, for flowers, plants and the like, that can be manufactured with known equipment and technologies.

The cachepot can in fact be produced for example with ordinary machines for producing hosiery and underwear.

It is evident that the cachepot can also be applied to objects that are not designed to contain flowers, such as for example interior decoration accessories having the most disparate shapes.

For example, the cachepot can be used conveniently to cover a pot or an interior decoration accessory in general that has suffered visible damage.

In practice, the materials used, so long as they are compatible with the specific use, as well as the dimensions, may be any according to requirements and to the state of the art.

The disclosures in Italian Utility Model Application No. PD2003U000044 from which this application claims priority are incorporated herein by reference.

What is claimed is:

1-9. (canceled)

10. A cachepot made of fabric, comprising a tubular element made of elastic fabric in order to adapt to a shape of a pot or of a pot with pot saucer to which it can be applied, said tubular element having two end borders that are also elastic.

11. The cachepot of claim 10, wherein said tubular element is made of elasticized knitted material.

12. The cachepot of claim 10, wherein said tubular element is made of stretch fabric.

13. The cachepot of claim 10, wherein said tubular element has regions with different elasticity.

14. The cachepot of claim 10, wherein said tubular element is made of a fabric that has thermal insulation properties.

15. The cachepot of claim 10, wherein said tubular element is made of washable fabric.

16. The cachepot of claim 10, wherein said tubular element is made of a fabric with anti-mold properties.

17. The cachepot of claim 10, wherein said tubular element is made of fabric having fire-resistant and/or self-extinguishing properties.

18. The cachepot of claim 10, wherein said tubular element is made of a fabric whose porosity has dimensions that prevent passage of mosquitoes.
